(19) United States
(12) Patent Application Publication
(10) Pub. No.: US 2020/0058085 A1
(43) Pub. Date: Feb. 20, 2020

(54) Solo travel pricing search engine

(71) Applicant: Elizabeth Smith Avery, Washington, DC (US)

(72) Inventor: Elizabeth Smith Avery, Washington, DC (US)

(21) Appl. No.: 15/998,694

(22) Filed: Aug. 16, 2018

(51) Int. Cl. G06Q 50/14; G06Q 30/06; G06Q 30/02

(52) U.S. Cl. CPC G06Q 50/14; G06Q 30/0605; G06Q 30/0283; G06Q 30/0627

(57) ABSTRACT

The present invention provides a method and system to identify, access and compare the best pricing options for travel services for individuals. This search engine identifies pricing methods ranging from those with no single supplement, reduced single supplement, sharing to avoid a single supplement, single parent pricing, solo-priced rooms or cabins as well as any other ways in which those traveling alone are charged. The user is able to combine a search for such a best pricing option for solo travelers with locations and types of travel offered. Alternatively, the user may choose a location alone to identify travel providers included in the solo travel search tool's database without specifying the type of travel services or pricing option. Search results then enable users to access directly providers, travel details and pricing to compare best offers for such services.

The present Invention concerns pricing disparities for those traveling alone, and more specifically the use of an apparatus, systems, and methods to identify, access and compare solo-priced travel services.

### BACKGROUND OF THE INVENTION

Travel services are generally priced for “doubles” or pairs and thereby charge solo travelers a surcharge or “single supplement”. In effect, individual travelers may have pricing that is one for the price of two.

The premium is even greater where early booking or other promotional offers for pairs are offered as “two for the price of one”. The solo traveler may then pay up to three times what is charged per person for those traveling as pairs or couples.

Existing travel search engines when queried by destination or tour type and pricing have several issues.

The first problem is that such queries can result in up to 2 million responses thereby too large to be useful, commingling results and too undifferentiated to provide solo travelers with useful information.

The second problem is that searches and/or websites that identify solo travel options typically use numeric rather than non-numeric rankings. The result is that a solo traveler must manually, or otherwise, compute a percentage for each desired trip to compare the level of penalty or pricing.

The next issue is that the existing search engines fail, in some cases, to state a single supplement figure but require an email, Internet or telephone query to the provider to obtain needed data.

Existing search engines and online solo travel resources do not provide an effective solution as to best pricing options for travel services.

With the standard currently being either an absence of solo pricing data or fragmented numerical listings as to tours and lodging for different dates, types and quality, the only way the user can evaluate pricing offered is by taking the time to research and convert each entry to a percentage.

### BRIEF SUMMARY OF THE INVENTION

The Invention provides a very friendly user interface on a computer or handheld or other electronic device with Internet access.

Users only need to decide a region of the world where they would like to travel via a drop down menu or other methodology.

Users can select among multiple types of travel again via drop down menu or other methodologies.

Users would have a drop down menu or other methodology for the user to select among the rankings or systems of solo travel pricing.

Users would obtain a listing of providers and URL contact links that meet their constraints as to destination, type of trip/lodging and solo travel pricing methodology using the Invention.

If no exact search result is found, the software program will automatically perform a “secondary” search that will take the user's location and preferred solo travel pricing method as inputs.

By eliminating the tour/lodging type, the user will see travel providers in their desired area correlated with their preferred solo travel pricing method. This will increase the likelihood of finding a match that meets the other two constraints and allows some aspect of flexibility even when an exact match is not found.

The Invention focuses initially has been for usage by solo travelers seeking the best pricing and travel option for an intersection set of a desired destination and type of leisure or business travel.

An additional embodiment is the opportunity for travel providers to use the Invention to market to the more than 27+ million growing, underserved solo travel marketplace.

A further embodiment is the use of the Invention as a digital alternative to traditional directories online or offline to identify travel providers offering services for solo travelers.

Further, other service providers can utilize the Invention as a means to connect with the computer medium to alert solo travelers to their own offers and products that complement travel.

### DETAILED DESCRIPTION OF THE INVENTION

As stated above, travel services are generally priced for “doubles” or pairs and thereby charge solo travelers a surcharge or “single supplement” of up to two to three times the rate charged pairs per person. The Invention claimed here solves this problem.

By allowing a user to identify, and access, travel providers that have solo pricing at no surcharge or a reduced fee, this software provides a method for individual travelers to identify, and obtain, pricing correlated to that available to those traveling in tandem.

The claimed Invention differs from what currently exists. Existing travel search engines respond to simple solo travel queries with uncorrelated entries of up to two million that fail to isolate solo travel options based on a non-numeric ranking of the surcharge assessed. The Invention provides a user-friendly method for solo travelers to access a destination, type of tour/trip/lodging correlated to multiple methods constituting the pricing mechanism for solo travelers.

This Invention is an improvement on what is available in the marketplace. Existing travel search engines respond to simple solo travel queries with uncorrelated millions of entries that fail to isolate solo travel options based on a non-numeric ranking of the surcharge assessed. The Invention provides a user-friendly method for solo travelers to access a destination, type of tour/trip/lodging correlated with multiple methods constituting the pricing mechanism for solo travelers.

Comparisons that are strictly numeric cannot readily identify the level of solo travel surcharge nor effective means of mitigating the extra cost, such as sharing, not the optimal solution for all solo travelers.

With the standard strictly numerical listings, the only way the user can evaluate pricing offered is by taking the time to research and convert each entry to a percentage.

The version of the Invention discussed here includes: 1.A computer or other apparatus 2. Computer keyboard 3. Mouse or other interface that can be manually manipulated for controlling on-screen cursor activity 4. Internet access 5.A database 6. Computer-readable medium (the software)

Relationship between the components: The computer keyboard (2) and mouse or other interface which can be manually manipulated for controlling on-screen cursor activity (3) are connected. The computer-readable medium (the software) (6) is installed on the computer or other apparatus (1) with its Internet access (4) to connect with (5) the proprietary database.

After the user has linked to the website, he/she may personally select among three constraints. The first is to choose among one of multiple worldwide regions. Secondly, he/she must select among a series of trip, lodging or tour types by activities or interests. Thirdly, he/she can choose between one of multiple methods of identifying and ranking the non-numeric basis for the solo travel pricing. Fourthly, the search will identify all travel providers and their URL's that are responsive to the three correlated queries of the user.

### How the Invention Works:

The software allows the user to identify and access travel providers for desired destinations correlated with activities and interests and further correlated with the level and method of pricing for solo travelers.

The computer or other apparatus acts as the central hub for this activity by providing access via the Internet for the user to choose a highly correlated travel option.

The if-then relationships are based on the following three core questions: does the location specified by the user match the location in the selected row of the database, does the tour/lodging type specified by the user match the tour/lodging type in the selected row of the database, and does the supplement type specified by the user match the selected row of the database? If any of these questions returns FALSE, the row is ignored, and the software will continue on to the next row in the database and repeat the process. In the event that at least a single match is found (where the answer TRUE is returned for all three questions in a single row), a marker called “IsFound” is set to TRUE, so that when the program is finished searching through the database, it knows that the search is finished. If this marker does not equal TRUE at the end of the search, it will automatically repeat the search but instead of three questions, it will only ask two: one regarding location and one regarding single supplement. The process is similar to the one described above but omits the question regarding tour/lodging type in order to allow more flexible search results. If the search still results in no found results, it will end the search and report to the user that no search results were found.

### SUMMARY

The Invention provides a method for users to identify lower solo-pricing penalties by accessing a proprietary database utilizing the intersection of destinations, type of trip/lodging and solo-pricing category.

The following elements are necessary: a computer, apparatus or mobile device, Internet connection, hosted website, and a pre-screened database. An optional element is a mouse or touchpad device, since it is quite possible for a user to use a stylus or one's finger to access the website and thus software from one's mobile device or touch-screen tablets/laptops and other such devices.

### BRIEF DESCRIPTION OF THE DRAWINGS

The Invention is further depicted using the drawings described below:

FIG. 1 is a high-level diagram of the software architecture of the Invention.

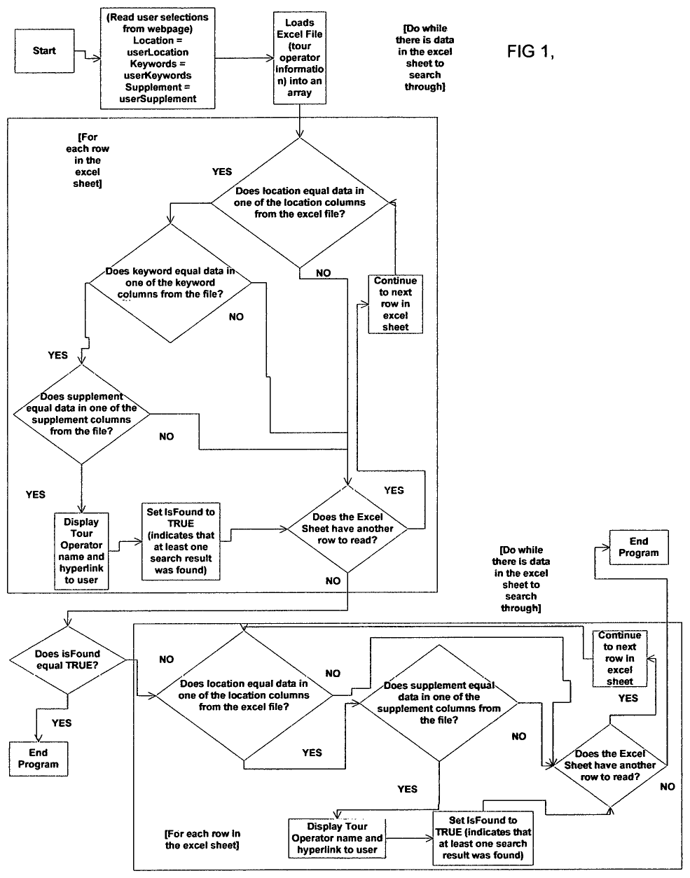

FIG. 2 depicts an example of a user submitting a product search to obtain the desired solo travel pricing.

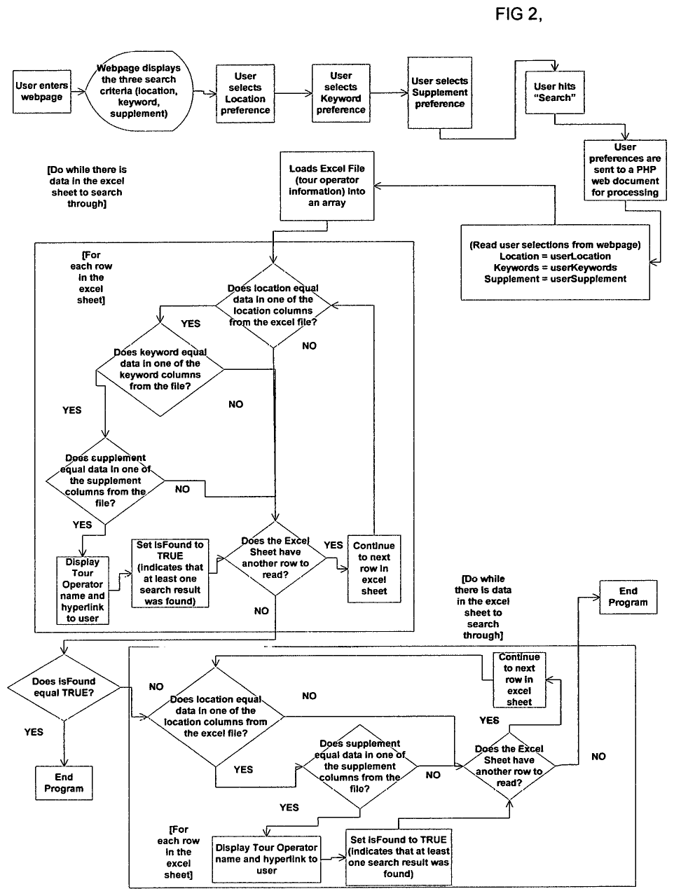

The figures are for purposes of illustration only.

### CROSS-REFERENCE TO RELATED APPLICATIONS

(NOT APPLICABLE)

### STATEMENT REGARDING FEDERALLY SPONSORED RESEARCH OR DEVELOPMENT

(IF APPLICABLE) (NOT APPLICABLE)

### REFERENCE TO SEQUENCE LISTING, A TABLE, OR A COMPUTER PROGRAM LISTING COMPACT DISC APPENDIX (IF APPLICABLE)

(NOT APPLICABLE)

1. A non-transitory computer-readable medium, comprising instructions to accept, and ability to accept, a request from a user to find a product or service by conducting a computerized search, calculating the non-numeric solo-priced options(s) meeting the user's chosen criteria, such as, intersecting with destination and type of tour, lodging or trip when executed by a processor or other apparatus, to do the following steps:

2. The method of claim 1, wherein data is loaded.

3. The method of claim 1, wherein a specialty search tool receives and responds to user requests.

4. The method of claim 1, wherein requesting a location selected from multiple entries.

5. The method of claim 1, wherein requesting the intersection set of multiple activity/trip types and the location selected.

6. The method of claim 1, further comprising: identifying the basis of pricing for solo travelers using a pre-selected non-numeric tracking system.

7. The method of claim 1, further comprising: identifying the optimal provider(s) that meet the queries as to the selected intersection of the select constraints.

8. The method of claim 1, further comprising a methodology of accessing one or more providers meeting the user's intersection set based on select constraints.

9. One or more storage devices storing instructions that are executable by an apparatus to perform operations comprising: presenting media content via an audio/visual display to a user to undertake a search for the intersection set of selected destination, tour/trip type and solo pricing methodology for determining the related surcharge.

10. The one or more storage devices of claim 9, wherein the instructions are executable by an apparatus to perform operations comprising the optimal selection influenced by pricing models.

11. The one or more storage devices of claim 9, wherein a solution sought is not available presenting alternative options based on the intersection of select constraints. In the event that no matches can be found using the inter section between the user's desired location, type of trip or tour, and tracking of one of multiple methods by which solo travelers are surcharged, the software will drop the type of trip or tour, and try searching with the user's desired location and supplement type that a solo traveler can be surcharged. By eliminating the user's third selection, it will increase the event of finding a match that meets the other two requirements for the user.

12. The one or more storage devices of claim 9, wherein the instructions are executable by an apparatus to perform operations comprising a solution to determine the optimal intersection of pricing surcharge and select constraints presenting identification of matching providers and their related access methodology.

13. The one or more storage devices of claim 9, wherein the instructions are executable by an apparatus to perform operations comprising: determining the intersection set between and among the user's desired location, type of trip or tour and tracking one of multiple methods by which solo travelers are surcharged.

14. The one or more storage devices of claim 9, wherein the instructions are executable by an apparatus to perform operations comprising: determining the intersection set of additional constraints between and among the user's queries correlated with tracking one of multiple methods by which solo travelers are surcharged.

15. A method performed by one or more processing devices or other apparatus, comprising: of, and presenting, media content via an audio/visual display to user's intersection set selected from constraints associated with the search request to obtain solo-travel pricing data and provide results to the user when executed by a processor or other apparatus, to do the following steps:

16. The method of claim 15, wherein data is loaded.

17. The method of claim 15, wherein a specialty search tool receives and responds to user requests.

18. The method of claim 15, wherein requesting a location selected from multiple entries.

19. The method of claim 15, wherein requesting the intersection set of multiple activity/trip types and the location selected.

20. The method of claim 15, further comprising: identifying the basis of pricing for solo travelers using a pre-selected non-numeric tracking system.

21. The method of claim 15, further comprising: identifying the optimal provider(s) that meet the queries as to the selected intersection of select constraints.

22. The method of claim 15, further comprising a methodology of accessing one or more providers meeting the user's intersection set based on select constraints.

23. One or more storage devices storing instructions that are executable by an apparatus to perform operations comprising: presenting media content via an audio/visual display to a user to undertake a search for the intersection set of selected destination, tour, lodging or/trip type and solo pricing methodology for determining the related surcharge.

24. The one or more storage devices of claim 23, wherein the instructions are executable by an apparatus to perform operations comprising the optimal selection influenced by pricing models.

25. The one or more storage devices of claim 23, wherein a solution sought is not available presenting alternative options based on the intersection of select constraints. In the event that no matches can be found using the inter section between the user's desired location, type of trip or tour, and tracking of one of multiple methods by which solo travelers are surcharged, the software will drop the type of trip or tour, and try searching with the user's desired location and supplement type that a solo traveler can be surcharged. By eliminating the user's third selection, it will increase the event of finding a match that meets the other two requirements for the user.

26. The one or more storage devices of claim 23, wherein the instructions are executable by an apparatus to perform operations comprising a solution to determine the optimal intersection of pricing surcharge and select constraints presenting identification of matching providers and their related access methodology.

27. The one or more storage devices of claim 23, wherein the instructions are executable by an apparatus to perform operations comprising: determining the intersection set between and among the user's desired location, type of trip or tour and tracking one of multiple methods by which solo travelers are surcharged.

28. The one or more storage devices of claim 23, wherein the instructions are executable by an apparatus to perform operations comprising: determining the intersection set of additional constraints between and among the user's queries correlated with tracking one of multiple methods by which solo travelers are surcharged.
